(19) United States
(12) Patent Application Publication
(10) Pub. No.: US 2014/0170610 A1
(43) Pub. Date: Jun. 19, 2014

(54) METHOD AND SYSTEM FOR CREATING CONTROLLED VARIATIONS IN DIALOGUES

(71) Applicant: Rosetta Stone, Ltd., Harrisonburg, VA (US)

(72) Inventors: Karl F. Ridgeway, Boulder, CO (US); Ronald Bryce Inouye, Harrisonburg, VA (US); Gregory Keim, Broadway, VA (US); Kyle D. Kuhn, Harrisonburg, VA (US); Jack August Marmorstein, Harrisonburg, VA (US); Robin Smith, Harrisonburg, VA (US); Brian Vaughn, Harrisonburg, VA (US)

(73) Assignee: Rosetta Stone, Ltd., Harrisonburg, VA (US)

(21) Appl. No.: 14/101,079

(22) Filed: Dec. 9, 2013

Related U.S. Application Data
(63) Continuation of application No. PCT/US2012/041934, filed on Jun. 11, 2012.
(60) Provisional application No. 61/520,390, filed on Jun. 9, 2011.

(51) Int. Cl. G09B 19/06

(52) U.S. Cl. CPC G09B 19/06
USPC 434/156

(57) ABSTRACT

A method and system for teaching a user a target language includes developing and constructing variable potential paths of nodes representing an exchange between two participants in a dialogue, prompting and selecting a path of nodes through a conversation graph of the target language, the path of nodes defining a dialogue; and determining whether the user is ready to perform the dialogue that has been constructed and defined by the path of nodes, the determination being based on a user model which represents the user's current ability in and current knowledge of, the target language. If the user is ready to perform the dialogue, the path of nodes is executed to allow the user to perform the dialogue defined thereby; and if the user is not ready to perform the dialogue, training the user on one or more nodes of the path of nodes.

### FIELD

The disclosure relates to language instruction. More particularly, the present disclosure relates to a method and system for automatically creating and presenting language content in a form of a dialogue (or mulitlogue, in the case of more than two participants).

### BACKGROUND

In its simplest form, a language learning dialogue for two participants, e.g., a language instructor or non-player character (NPC) and a language learner (user), can be represented as a script in a target language (language to be learned), in which the utterances that each participant says are written down, and in a specified order. In the script case, the dialogue is exactly the same with every repetition. As a result, the user can simply memorize his or her utterances in the required order. Once this memorization task has been accomplished, the user can successfully perform the script-based dialogue simply by repeating the utterances in the correct order, without regard to the meaning of the utterances stated by the NPC.

While there are certainly some benefits to script memorization as a language learning exercise, it suffers from at least two major flaws. The first flaw, as previously noted, is that it is possible to succeed in completing a scripted dialogue without any comprehension at all. This is no different than training a parrot to say the lines in the appropriate order. The second flaw is that such practice becomes repetitive and boring, as the task does not change from iteration to iteration.

In order to prevent the user from memorizing the script, without regard to meaning, we can employ a tree-based data structure to introduce variations to the dialogue. By introducing branching points in the dialogue, we remove the linear predictability from the dialogue. Upon repetition of the dialogue, the system can create novel variations by making different choices at each branch point. With properly constructed dialogue content, the user must understand the NPC utterance in order to respond appropriately. The range of allowable utterances is still memorized and finite, but the order in which the utterances are used vary from dialogue to dialogue.

While tree-branching dialogues allow a great deal of flexibility in their ability to present new variations of dialogues in the user experience, they are cumbersome to construct and maintain. Each variation must be separately constructed. Variations generated by choice points far down the tree share a common subsequence up until the branch point, so the degree of variation may not be great for many of the realized dialogues. Variations that share a common subsequence at the end cannot be compactly represented.

Accordingly, a content authoring, sequencing and delivery method and system is needed that provides variations including but not limited to reordering of subsequences of the dialogue, allows optional inclusion/omission of subsequences of the dialogue, semantically stable rewording of NPC prompts, variable substitution in user utterances, and change in non-linguistic context, in a time- an space-efficient manner.

### SUMMARY

Disclosed herein is a method for teaching a user a target language. The method comprises: selecting, in a computer process, a path of nodes through a conversation graph of the target language, the path of nodes defining a dialogue; determining, in a computer process, whether the user is ready to perform the dialogue defined by the path of nodes, the determination being based on a user model which represents the user's current ability in and current knowledge of, the target language; if the user is ready to perform the dialogue, executing the path of nodes, in a computer process, to allow the user to perform the dialogue defined thereby; and if the user is not ready to perform the dialogue, training the user, in a computer process, on one or more nodes of the path of nodes.

Further disclosed herein is a system for teaching a user a target language. The system comprises a computer operable for: selecting a path of nodes through a conversation graph of the target language, the path of nodes defining a dialogue; and determining whether the user is ready to perform the dialogue defined by the path of nodes, the determination being based on a user model which represents the user's current ability in and current knowledge of, the target language. If the user is ready to perform the dialogue, the central processing unit executes the path of nodes to allow the user to perform the dialogue defined thereby, and if the user is not ready to perform the dialogue, the central processing unit trains the user, on one or more nodes of the path of nodes.

Also disclosed herein is a system and method for constructing a dialogue for use in teaching a user a target language. The method comprises: generating a conversation graph of the target language, the graph including a plurality of nodes, each of the nodes including an NPC utterance that is capable of eliciting a certain utterance from the user; training the user, in a computer process, on one or more of the nodes; and selecting, in a computer process, a path of nodes through the graph to present to the user, the path of nodes selected based on results of the training, to present to the user.

### BRIEF DESCRIPTION OF THE DRAWINGS

FIG. 1 is a schematic illustration of an exemplary embodiment of a graph-based representation (graph structure) of an instructional conversation between an NPC and a language learner or user.

FIGS. 2-6 schematically illustrate the use of the graph-structure of FIG. 1 in various language learning instances.

FIG. 7 is a flowchart illustrating the operation of a content sequencing engine of the present disclosure.

FIG. 8 is a block diagram of an exemplary embodiment of a language learning system of the present disclosure.

FIG. 9 is a block diagram showing of an exemplary embodiment the computer system of the language learning system of FIG. 8.

FIG. 10A schematically illustrates an exemplary embodiment of a subgraph for a SERIAL-group of nodes.

FIG. 10B illustrates an exemplary embodiment of a dialogue for a subgraph of a SERIAL-groups of nodes.

FIGS. 11A schematically illustrates an exemplary embodiment of a subgraph for an AND-group of nodes.

FIG. 11B illustrates an exemplary embodiment of a dialogue for a subgraph for an AND-group of nodes.

FIG. 12A schematically illustrates an exemplary embodiment of a subgraph for a XOR-group of nodes.

FIG. 12B illustrates an exemplary embodiment of a dialogue for a subgraph of a XOR-group of nodes.

### DETAILED DESCRIPTION

From a language learning perspective, it is desirable to have high variability in the number of unique utterances in the language to be learned (target language) that the NPCs say, while keeping the number of unique user utterances in the target language low. Pedagogically, this principle is consistent with the idea that beginning and intermediate learners should be capable of understanding a wide range of input, but only need to be concerned about having one good way of producing output. Therefore, the variable dialogue creating method and system (method and system) of the present disclosure may, in some embodiments, restrict the number of unique user utterances in a target language, thereby allowing better information to be provided to an automated speech recognizer (ASR) of the system so that the ASR can act as a reliable interlocutor in human/user-machine dialogues.

As described earlier, using a tree to represent the content in a conversational content set provides some gains in reducing the overall size of the data structure required to encode the data, but each possible variation that the user might see must ultimately be encoded explicitly in the tree. In some embodiments of the method and system of the present disclosure, a dialogue may be represented in a graph-based model so that the number of variations represented in the content can be increased while simultaneously eliminating the need to hand-author each variation.

In the graph-based dialogue representation (graph structure) of the method and system of the present disclosure, each node may represent two consecutive utterances in a dialogue of a conversational content set, where one of the two utterances is spoken by a non-player character (NPC) in the target language and the other one of the two utterances is spoken by a user in the target language in response to the utterance spoken by the NPC. The NPC can be either a computer or a human coach or instructor. In the graph structure, not only can variations branch away from each other at a node, as in the tree-based representation, but they can also merge back together. Adding this ability makes the structure more compact.

In addition to allowing branches to merge, some embodiments of the graph structure may comprise SERIAL-groups of nodes, AND-groups of nodes, XOR-groups of nodes, optional nodes, and any combination thereof, to increase the number of variations expressible by the graph without increasing the size of the graph.

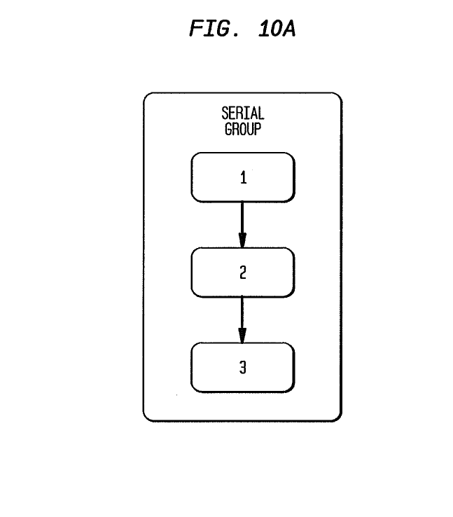

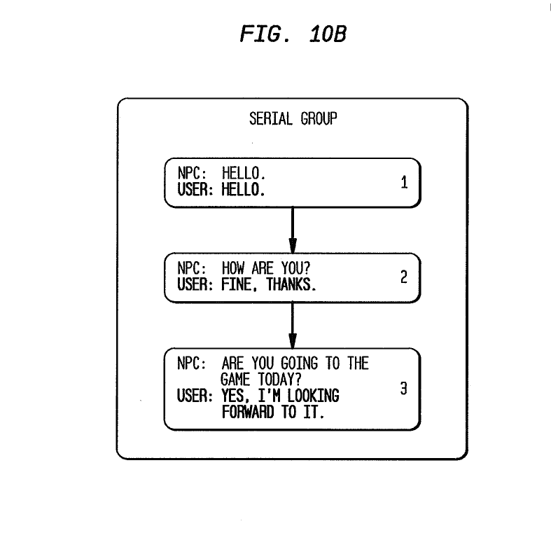

As shown in FIGS. 10A and 10B, the SERIAL-groups, in some embodiments, may comprise a sequence of graph nodes (e.g., nodes 1, 2, and 3 of FIG. 10A) that have a sequential linear relationship. In the non-limiting example of FIG. 10A, the SERIAL-group generates exactly one path, namely 1-2-3. The nodes may represent sections of the dialogue that are scripted with no variation. The SERIAL-groups do not provide expressive power in and of themselves, but exist to group nodes together for use by other constructs.

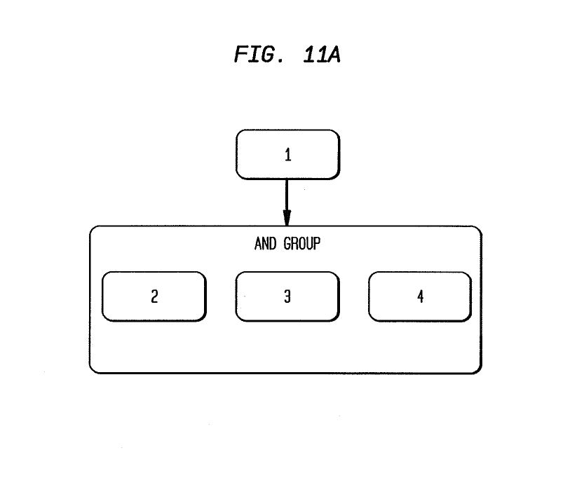

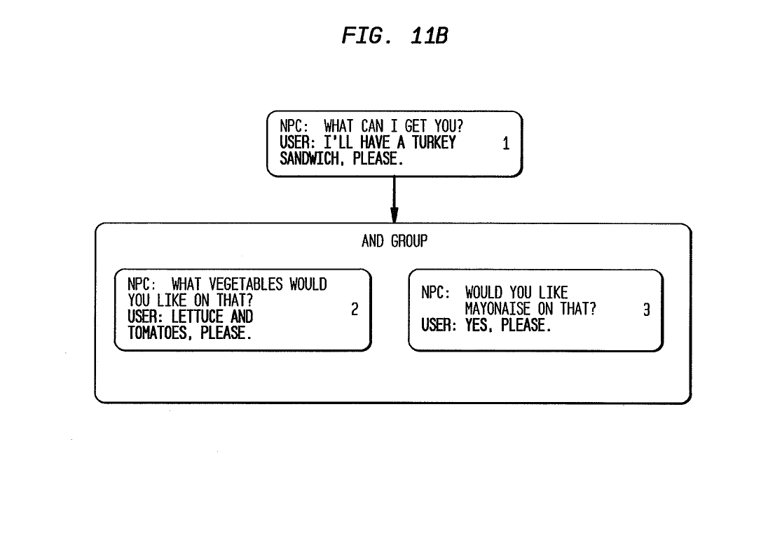

As shown in FIGS. 11A and 11B, the AND-groups, in some embodiments, may comprise a set of sibling nodes and/or groups (e.g., nodes 2, 3, and 4 of FIG. 11A). In the non-limiting example of FIG. 11A, the AND-group generates 6 possible dialogues: 1-2-3-4; 1-2-4-3; 1-3-2-4; 1-3-4-2; 1-4-2-3; and 1-4-3-2. The semantics of the AND-group may comprise that each time the dialogue passes through the AND-group, the dialogue may use all of the nodes within the AND-group before continuing to a child of the AND-group, but the order in which the constituents of the AND-group are presented may be selected at random.

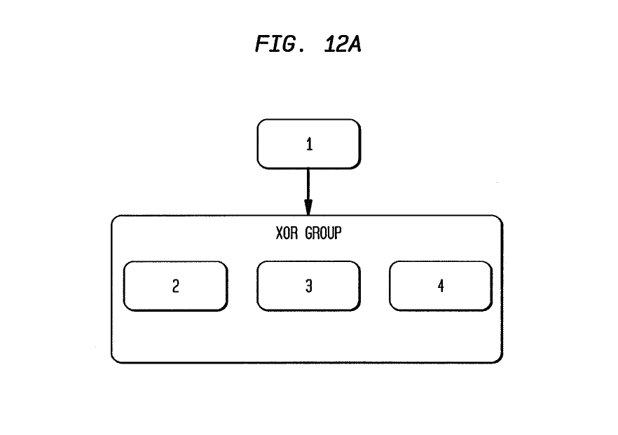

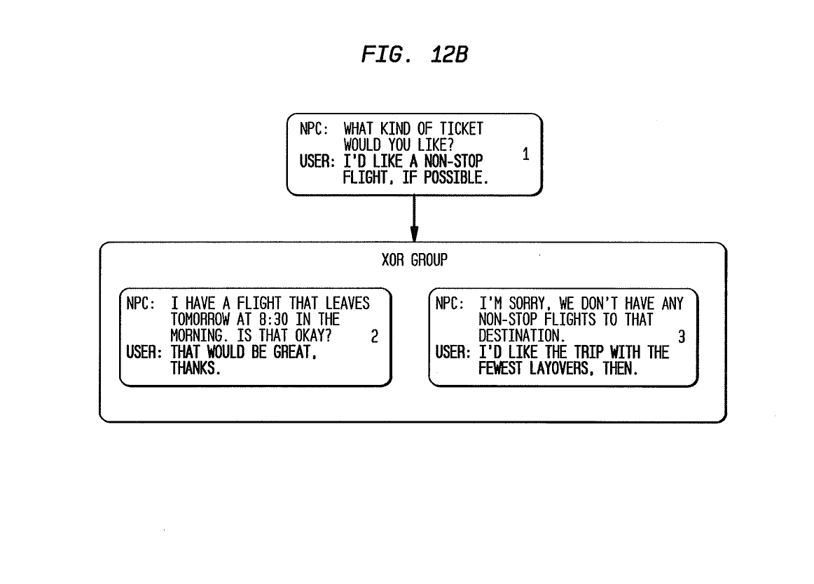

As shown in FIGS. 12A and 12B, the XOR-groups, in some embodiments, may comprise a set of sibling nodes and/or groups (e.g., nodes 2, 3, and 4 of FIG. 12A). In the non-limiting example of FIG. 12A, the XOR-group generates 3 possible dialogues: 1-2-1-3; and 1-4. The semantics of the XOR-group may comprise that each time the dialogue passes through the XOR-group, exactly one of the constituent nodes and/or groups will be presented.

The optional nodes, in some embodiments, may comprise nodes that have some probability (decided either globally, per node, or per learner) of not being presented when the dialogue passes through that node.

The graph structure comprising the one or more groups and/or special nodes allows for compact representations of dialogue spaces comprising thousands of possible variations. The relatively small size of the data structure means that authoring and editing such content can be done in a fraction of the time that it would take to produce and maintain that many variations by hand.

Some embodiments of the method and system of the present disclosure may use a dialogue model that requires that users memorize a relatively small set of lines. The primary dialogue task for the user is to attend to what the interlocutor is saying and decide in a timely fashion which of the allowable utterances is appropriate given the situation.

Some embodiments of the method and system of the present disclosure may apply a template/variable structure to the user's utterances to extend the number of different utterances that the user may say without significantly increasing the cognitive load on the user. In one embodiment, some or all of the user's utterances may have sections that can be replaced by a variety of alternatives. For example, but not limitation, in a particular conversation set the user may be allowed to say “I'm planning on going to the store tomorrow.” Given different situations in the same conversation set, the user may instead say “I'm planning on going to the office tomorrow” or “I'm planning on going to the beach tomorrow.” In this example, “I'm planning on going to X tomorrow” comprises the template and “X” comprises the variable, which may take on the values “the store,” “the office,” or “the beach.” As long as the correct value of the variable is clearly communicated, many more variations in the user utterances can be generated without significantly increasing the amount of material the user must memorize.

Some embodiments of the method and system of the present disclosure utilize a content model capable of generating a vast array of user experiences that resemble each other but that pose novel challenges to users upon each encounter. Because the number of possible variations is so great, a content sequencing algorithm (CSA) based on a predictive user model, may be provided in some embodiments of the method and system of the present disclosure, for selecting which content variations should be presented to the user at any given moment.

The CSA's predictive user model is constructed using one or more of a plurality of factors including, but not limited to: 1) the projected amount of time left in a current training session (how many minutes left today); 2) the projected amount of time left in overall training for a current conversation set (how many days of training left); 3) the observed knowledge of user; 4) the predicted knowledge of user; 5) the observed ability of user; 6) the predicted ability of user; 7) the available content in upcoming complementary live instruction; 8) and the predicted maximum rate of content mastery by the user. The user model, which is updated every time the user interacts with the system, is used by the CSA to determine which content variation (NPC/user utterances) to present to the user. The CSA at any given time, may determine what content to present to the user in order to present a manageable challenge, given the knowledge and ability of the user (i.e., as per the current user model), and that moves the user along towards an intermediate target language learning goal.

In some embodiments of the method and system of the present disclosure, the CSA generates different modes of user training and practice, which may serve different pedagogical purposes. The different modes may, in some embodiments, comprise an introduce mode, a rehearse mode and a perform mode. The introduce mode may comprise a mode where the CSA does not prompt the user to interact with the NPC at all, but merely listens and watches the NPC perform both sides of a given dialogue or conversation set.

The rehearse and perform modes serve to train the user in a set of possible utterances in a conversation set. This can be an end in and of itself; the content set (the set of possible utterances) may exist purely to assist the user to memorize a set of stock phrases to use in particular situations. In the rehearse and perform modes, the CSA may determine which user utterance should be trained, based on the probability that the user will be able to perform a specified rehearse or perform task with that utterance. The tasks may include, but are not limited to, one of, or some combination of the following, listed in decreasing order of difficulty: 1) oral production of an utterance, by the user in response to an NPC prompt (utterance) designed to elicit specifically that utterance, where the user has not previously seen or heard the NPC prompt before (perform mode); 2) oral production of an utterance by the user in response to an NPC prompt (utterance) designed to elicit specifically that utterance, where the user has previously seen the utterance associated with the given NPC prompt before (perform mode); 3) repetition of an utterance by the user after hearing a recording of the native speaker saying the utterance (rehearse mode); 4) the user reading an utterance out loud when presented with the text of the utterance on, for example, a display screen of a computer (rehearse mode); and 5) the user saying an utterance in pieces (a word or a few words at a time), prompted by a recording of a native speaker saying each piece and/or the text of each piece being displayed on, for example, a display screen of a computer (rehearse mode).

The goal of the training is to increase the probability that the user will be able to perform the most difficult task (i.e., task 1) mentioned above) for each utterance. Specifically, for a given dialogue situation in which only one user utterance of the set of utterances in the conversation set is appropriate, the user should be able to recognize which utterance to use, and to produce it acceptably in a timely fashion. To achieve this goal, the CSA presents the user with a task or tasks for each utterance that is/are commensurate with the user's current ability to perform on that utterance.

For example, but not limitation, the CSA may initially prompt the user to perform task 4, i.e., read the utterance out loud given the text on-screen, because the CSA has determined that there is a high probability that the user will be capable of doing task 4 and a low probability that the user will be capable of performing task 1, i.e., orally producing the exact utterance given only an NPC prompt designed to elicit that utterance. After the user reads the utterance a few times (performs task 4), and repeats it given an audio recording of a native speaker saying the utterance (performs task 3), the probability that the user will be capable of producing the utterance in response to an NPC prompt eventually increases to a point where the probabilistic user model used by the CSA may estimate or predict that the user has a high enough probability of succeeding at performing task 1, and therefore, it is reasonable to prompt the user to perform task 1.

In addition to determining which tasks to present to the user to train the user in the use of a specific user utterance in a conversation set, the CSA, in some embodiments, may also determine which user utterances to train the user on, and in what order. These decisions are driven by the anticipated need of the user to employ the utterances in a dialogue. Such dialogues can take place in two settings, in a human-computer interaction, or a human-human interaction.

Ultimately, it is desirable to train users to interact in dialogue with other humans in the target language. In some embodiments of the method and system of the present disclosure, human-computer dialogues are used as a low-cost method for training the user in performing such dialogues. Additionally, using a computer as the interlocutor in a dialogue makes it possible for the CSA to have greater control over what content the user sees, so that his or her performances can be designed to have the maximal training impact. A further benefit of using human-computer dialogues for training is that users may experience less anxiety in practicing with a machine than with a human native speaker of the target language they are studying.

The CSA, in some embodiments of the method and system, prioritizes the training of the user utterances for the conservational content et in order to maximize the probability that the user will succeed at the dialogue when he or she participates in it. The CSA may prioritize the training based on when the user's next dialogue will happen, and the anticipated content of that dialogue.

In some embodiments of the method and system of the present disclosure, the user may be periodically presented, during the course of the user's training in a conversational content set, with opportunities to interact in a dialogue setting with a live human interlocutor (or “coach”). The interlocutor may have an interface that interacts with the CSA to serve up a path of content for the coach to present to the user. The CSA selects content based on its knowledge of the training state of the user on the conversation set.

There may be several possible modes in which the coach may interact with the user. A first mode of interaction, in some embodiments of the method and system, may comprise the coach playing the role(s) played by the computer in the automated training. In this mode, the CSA may generate a dialogue for the user to play through. The content of the dialogue may be presented to the coach to read via the interface.

During the live conversation with the coach, the user may see and/or hear essentially the same information that he or she sees and/or hears when practicing with the computer. There may be some additional information available, such as a video feed of the coach, but the interaction is substantially the same as in training with the computer, with the notable exception of the presence of a human instructor as the evaluator of the fitness of the user's utterances.

Because of the integration of the live human dialogue environment with the computer dialogue training environment, users are able to practice their dialogue skills in a cost-efficient manner before actually interacting with a human coach or instructor. They arrive with confidence in their abilities to perform the dialogue tasks which the coach presents them with, and a familiarity with the content that they will be asked to engage.

For some language learning applications, an embodiment of the method and system of the present disclosure may comprise a live-coach environment where the content never deviates significantly from the variations capable of being generated and presented in the software training dialogue interface. For other language learning applications, an alternate embodiment of the method and system of the present disclosure may comprise a live-coach dialogue interface which allows the human coach to generate his or her own variations on the dialogues in the conversation set, building upon the training base already present. The end goal of such an embodiment is to enable users to be able to handle a greater variety of situations than can be efficiently authored, modeled, and presented in that interface. In such an embodiment, the CSA provides information to the coach about what content the user is familiar with, and the level of ability to perform on individual pieces of content.

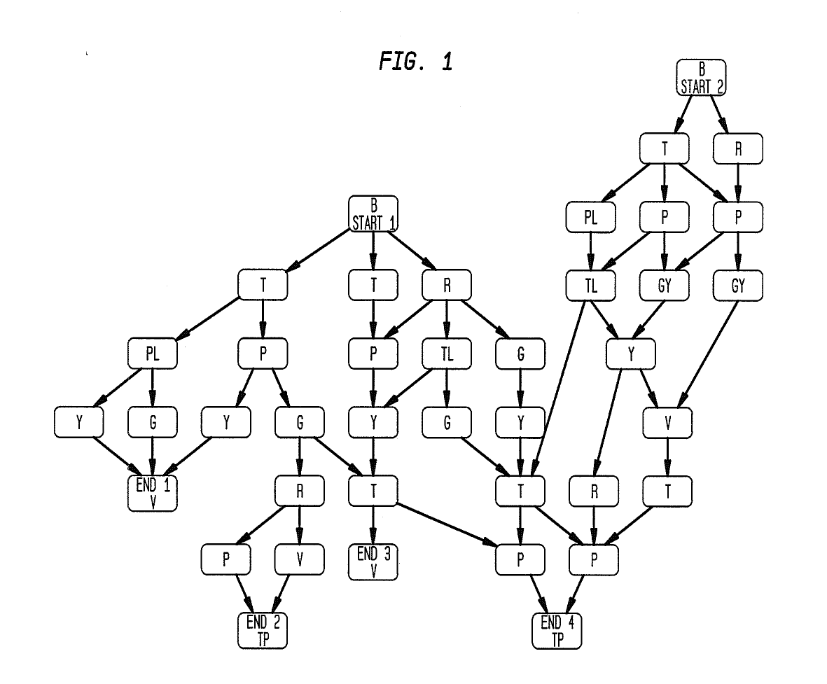

FIG. 1 shows an exemplary embodiment of a graph structure, which represents a conversation set that a user might be trained on. Each node in the graph represents two consecutive utterances in a dialogue, one said by an NPC and the other said by the user. The letter indicated in each of the nodes represents the content of the user utterance. In nodes that have the same letter, the user says the same utterance, although the NPC utterance may differ; A conversation begins at either start node labeled “Start 1” and “Start 2” (both user utterance B) and follows the arrow links until it reaches one of the end nodes labeled “End 1” (user utterance V) “End 2” (user utterance TP), “End 3” (user utterance V), and “End 4” (user utterance TP).

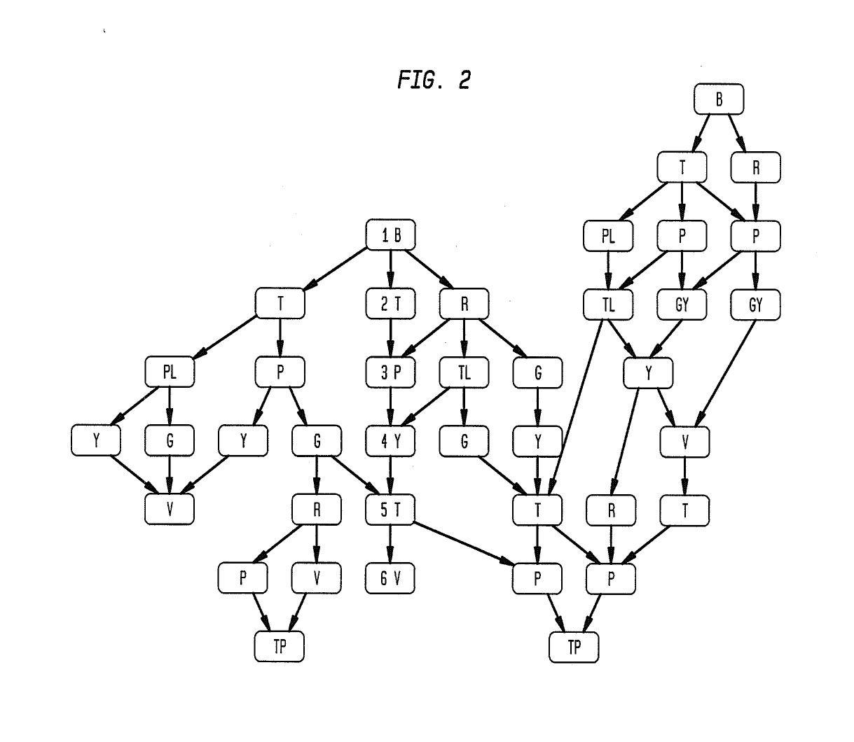

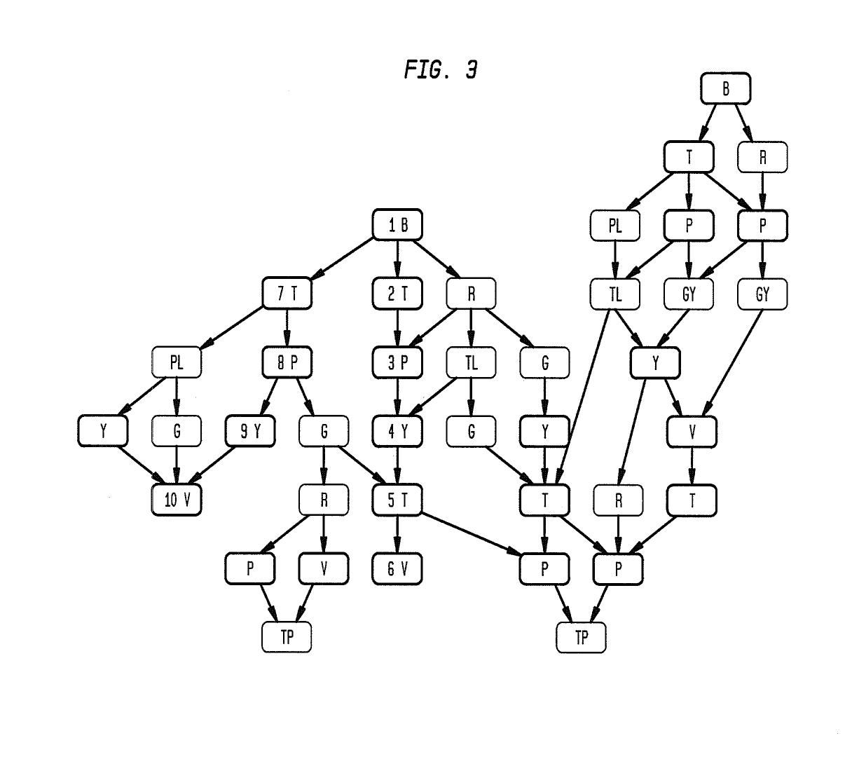

The method and system of the present disclosure will now be illustrated with reference to the conversation set shown in FIG. 1 and the following non-limiting language learning scenarios where the CSA selects content to fill a twenty minute training studio session with a live human coach. FIG. 2 shows an exemplary embodiment of a path through a conversational content set (active path), denoted by nodes 1-2-3-4-5-6, through the conversational content set of FIG. 1, that the CSA may present during the session. In order for the user to successfully complete the active path, for each of the nodes 1-2-3-4-5-6 of the active path, given the NPC utterance in each node, the user will have to successfully identify the proper response and produce it orally in a manner capable of being verified by the system. Prior to the studio session, the CSA may have previously trained the user on each of the user utterances represented by the nodes of active path 1-2-3-4-5-6 individually, using one or more of the introduce, rehearse, and perform, training modes, mentioned earlier. Further, the CSA may have presented the active path 1-2-3-4-5-6 to the user in a computer training session and the user may have completed the active path 1-2-3-4-5-6 successfully with the computer. A successful performance of the active path in the studio session with the live human coach demonstrates that the user has the knowledge and ability to produce the utterances B, T, P, Y, T, and V in nodes 1 through 6. This also demonstrates that the user may know and can produce the utterances in all the nodes outlined in FIG. 3. In particular, the user may know all of the utterances necessary to perform the complete conversation represented by the node path labeled 1-7-8-9-10. The NPC utterances in that conversation may differ from the ones seen in the path 1-2-3-4-5-6, which means that the user will have to understand the NPC utterances successfully in order to complete the conversation. The CSA may then select the path 1-7-8-9-10 as a second path through the conversational content set to present in the studio session, because it is a novel experience that does not require any additional user training in order for the user to complete it.

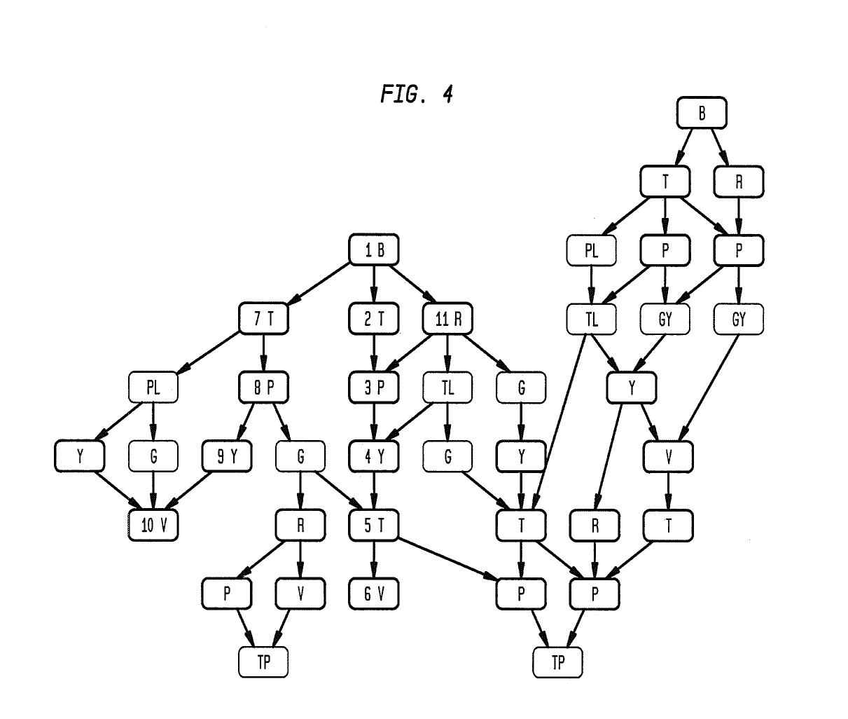

Referring now to FIG. 4, the CSA may select content for the user to train and perform within a second studio session. The CSA may determine that by training on node 11 (user utterance R), the user can then perform the conversation of path 1-11-3-4-5-6. FIG. 4 shows the extent of the graph covered by the user's training after training on node 11.

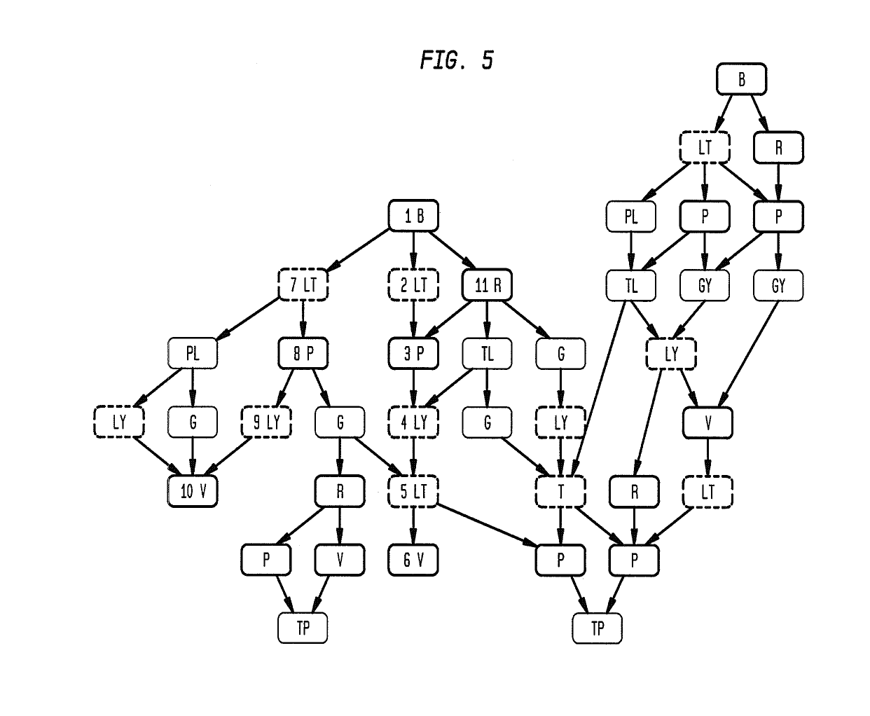

FIG. 5 shows one exemplary state of the user's ability after performing the path 1-11-3-4-5-6 in the second studio session. The live coach observes during this session that the user performed poorly on nodes 4 and 5 (user utterances Y and T, respectively), which are now outlined with broken lines and designated LY and LT, respectively. The other nodes containing user utterances Y and T are also now outlined with broken lines and redesignated LY and LT, respectively, indicating that the user has trained on those utterances, but is unable to perform well on them. With the nodes containing user utterances Y and T unavailable, there are no complete conversations available. Therefore, the CSA may select to remediate those utterances before introducing new content.

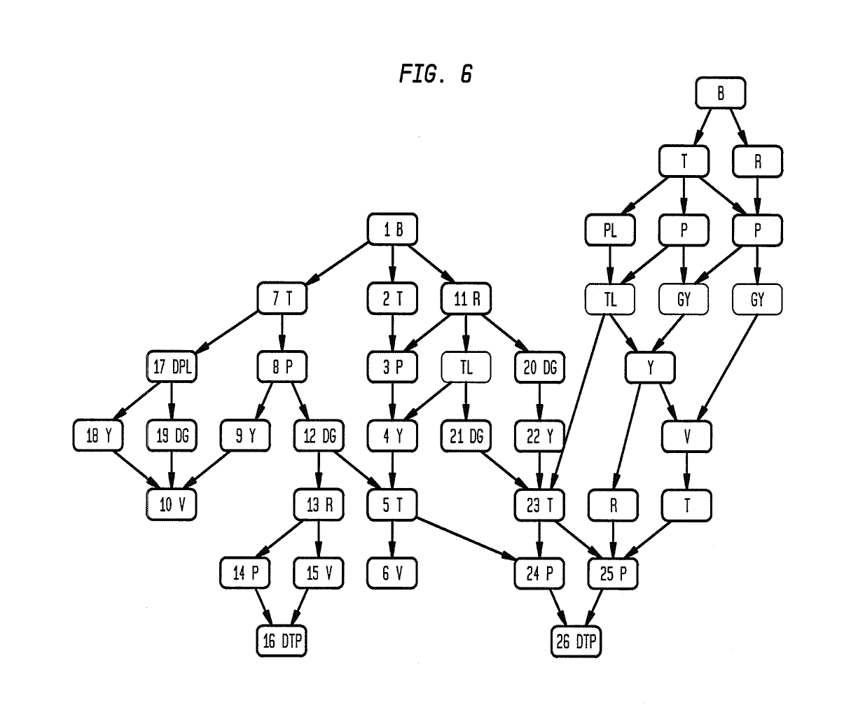

FIG. 6 shows one exemplary state of the user's ability after the remediation has been completed. As shown, the CSA has introduced the nodes containing utterances DPL, DG, and DTP. At this point of learning, nearly all of the paths in the conversational content set reachable from node 1 are available for performance in training or in studio. At this point, the CSA has many options available. The CSA may continue to introduce new content (e.g., the nodes containing user utterances TL and GY). In addition, the CSA may present conversations that the user is prepared for, but has not yet seen. Further, the CSA may present conversations that the user has already performed.

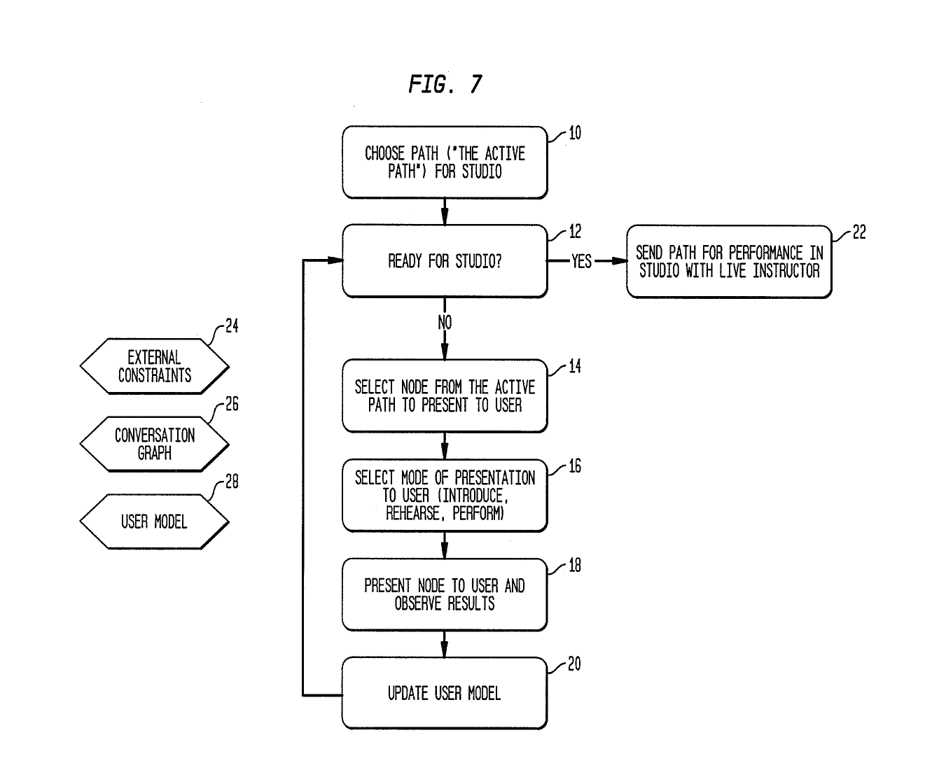

FIG. 7 is a flowchart illustrating the operation of the CSA of the present disclosure. The logic flow through the method considers external constraints (block 24) including but not limited to the availability of a studio coach, the number of studio sessions available under the terms of a learner's software license, the quality of the user's computer system such as the internet connection, the camera, and the microphone. In block 10, the CSA selects an active path through a predetermined conversation set which may be represented by a graph structure (block 26). A default active path may be selected if there has been no previous interaction with the user. After that, the CSA may use the predictive user model of block 28 (which is updated after the first interaction) to select the appropriate active path for the user. If one or more previous interactions have taken place with the user, the CSA may use the predictive user model of block 28 (which is updated after each interaction with the user) to select the appropriate active path for the user. The CSA determines in block 12 whether or not the user is ready to perform the active path in a studio session with a human coach or instructor. This decision may be based on previous interactions with the user (user model 28), the graph structure 26, and/or the external constraints of block 24. Typically, the CSA will select “no” if no previous interaction has taken place with the user and the logic will flow to user training blocks 14, 16, and 18. If the CSA determines in block 12 that the user is ready to perform the active path, the logic flows to block 22 where the active path may be sent to the human coach or instructor's interface that interacts with the CSA to serve up content for the coach or instructor to present to the user. The coach or instructor may then present the active path to the user to perform in a studio session. In block 14, the CSA selects a node from the active path to present to the user for training. The node selection may be based on the current status of the predictive user model 28, the graph structure 26, and/or external constrains 24. The logic then flows to block 16 where the CSA selects the training mode to present to the user, which again, may be based on the current status of the predictive user model 28, the graph structure 26, and/or external constraints 24. The logic flows to block 18 where the CSA presents the node to the user for training and observes and analyzes the user's utterances. The user model of the CSA is updated in block 20 according to the observation and analysis performed by the CSA in block 18 and the logic flows back up to block 12.

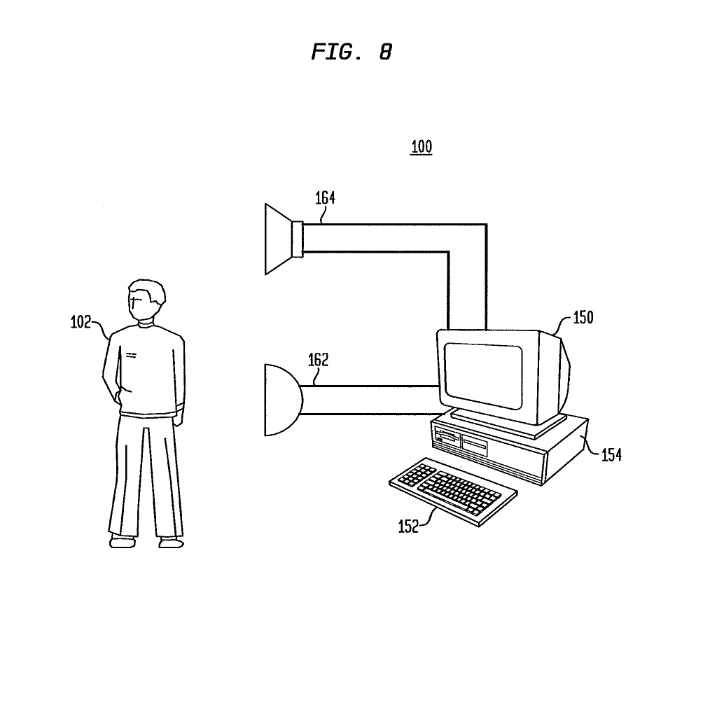

FIG. 8 is a schematic block diagram of an exemplary embodiment of a language instruction system 100 according to the present disclosure. The system 100 may include a computer system 150 and audio equipment suitable for teaching a target language to user 102, in accordance with the principles of the present disclosure. Language instruction system 100 may interact with one user 102 (language student), or with a plurality of users (students). Language instruction system 100 may include computer system 150, which may include keyboard 152 (which may have a mouse or other graphical user-input mechanism embedded therein) and/or display 154, microphone 162 and/or speaker 164. Language instruction system 100 may further include additional suitable equipment such as analog-to-digital converters and digital-to-analog converters to interface between the audible sounds received at microphone 162, and played from speaker 164, and the digital data indicative of sound stored and processed within computer system 150.

The computer 150 and audio equipment shown in FIG. 8 are intended to illustrate one way of implementing the method and system of the present disclosure. Specifically, computer 150 (which may also referred to as “computer system 150”) and audio devices 162, 164 preferably enable two-way audio communication between the user 102 (which may be a single person) and the computer system 150. Computer 150 and display 154 enable visual displays to the user 102. If desired, a camera (not shown) may be provided and coupled to computer 150 to enable visual data to be transmitted from the user to the computer 150 to enable instruction 100 to obtain data on, and analyze, visual aspects of the conduct and/or speech of the user 102.

In one embodiment, software for enabling computer system 150 to interact with user 102 may be stored on volatile or non-volatile memory within computer 150. However, in other embodiments, software and/or data for enabling computer 150 may be accessed over a local area network (LAN) and/or a wide area network (WAN), such as the Internet. In some embodiments, a combination of the foregoing approaches may be employed. Moreover, embodiments of the present disclosure may be implemented using equipment other than that shown in FIG. 8. Computers embodied in various modern devices, both portable and fixed, may be employed including but not limited to Personal Digital Assistants (PDAs), cell phones, tablets, among other devices.

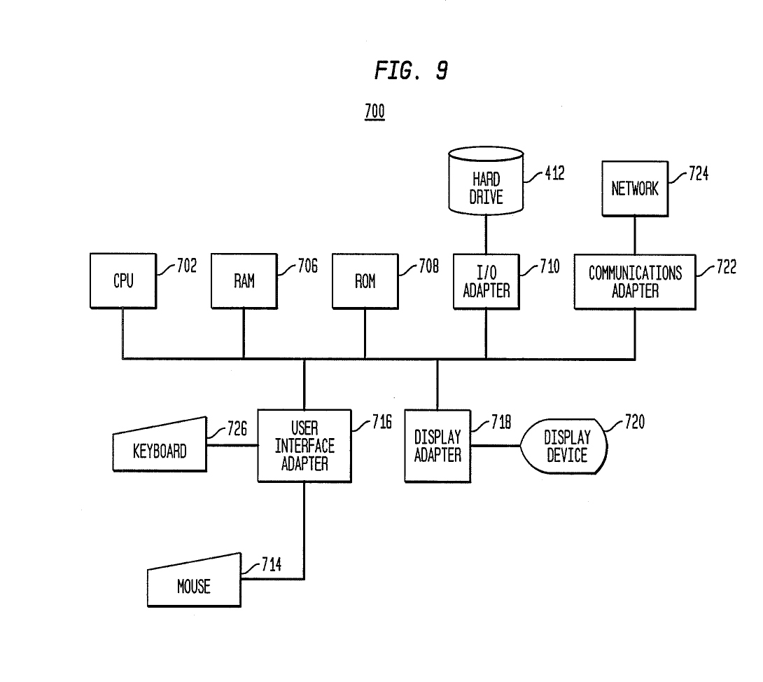

FIG. 9 is a block diagram of a computer system 700 that may be used for implementing the computer system 150 of FIG. 8. Central processing unit (CPU) 702 may be coupled to bus 704. In addition, bus 704 may be coupled to random access memory (RAM) 706, read only memory (ROM) 708, input/output (I/O) adapter 710, communications adapter 722, user interface adapter 706, and display adapter 718.

In an embodiment, RAM 706 and/or ROM 708 may hold user data, system data, and/or programs. I/O adapter 710 may connect storage devices, such as hard drive 712, a CD-ROM (not shown), or other mass storage device to computing system 600. Communications adapter 722 may couple computing system 700 to a local, wide-area, or global network 724. User interface adapter 716 may couple user input devices, such as keyboard 726, scanner 728 and/or pointing device 714, to computing system 700. Moreover, display adapter 718 may be driven by CPU 702 to control the display on display device 720. CPU 702 may be any general purpose CPU.

While exemplary drawings and specific embodiments of the disclosure have been described and illustrated, it is to be understood that that the scope of the invention as set forth in the claims is not to be limited to the particular embodiments discussed. Thus, the embodiments shall be regarded as illustrative rather than restrictive, and it should be understood that variations may be made in those embodiments by persons skilled in the art without departing from the scope of the invention as set forth in the claims that follow and their structural and functional equivalents.

1. A method for teaching a user a target language, the method comprising:
selecting, in a computer process, a path of nodes through a conversation graph of the target language, the path of nodes defining a dialogue;
determining, in a computer process, whether the user is ready to perform the dialogue defined by the path of nodes, the determination being based on a user model which represents the user's current ability in and current knowledge of, the target language;
if the user is ready to perform the dialogue, executing the path of nodes, in a computer process, to allow the user to perform the dialogue defined thereby; and
if the user is not ready to perform the dialogue, training the user, in a computer process, on one or more nodes of the path of nodes.

2. The method of claim 1, wherein the conversation graph comprises a graph-based representation of content of a conversation.

3. The method of claim 1, wherein each of the nodes includes a non-player character (“NPC”) utterance that is capable of eliciting a certain utterance from the user, the utterances forming a portion of the dialogue.

4. The method of claim 1, wherein each of the nodes includes multiple NPC utterances, each of which is capable of eliciting the same utterance from the user.

5. The method of claim 1, wherein the selection of the path of nodes is based on a default path or the user model.

6. The method of claim 1, wherein the training of the user includes selecting one of the nodes of the selected path of nodes to present to the user for training.

7. The method of claim 6, wherein the training of the user further includes selecting one of a plurality of presentation modes.

8. The method of claim 7, wherein the plurality of presentation modes includes an introduce mode, a rehearse mode, and a perform mode.

9. The method of claim 7, wherein the training of the user further includes presenting the selected node to the user and observing the user's utterance.

10. The method of claim 9, wherein training of the user further includes updating the based on the observation of the user's utterance.

11-14. (canceled)

15. A system for teaching a user a target language, the system comprising:
a computer operable for:
selecting a path of nodes through a conversation graph of the target language, the path of nodes defining a dialogue;
determining whether the user is ready to perform the dialogue defined by the path of nodes, the determination being based on a user model which represents the user's current ability in and current knowledge of, the target language;
wherein if the user is ready to perform the dialogue, the central processing unit executes the path of nodes to allow the user to perform the dialogue defined thereby; and
wherein if the user is not ready to perform the dialogue, the central processing unit trains the user, on one or more nodes of the path of nodes.

16-24. (canceled)

25. The system of claim 15, wherein the training of the user includes production of an utterance by the user in response to an NPC utterance, where the user has not previously observed the NPC utterance before; production of an utterance by the user in response to an NPC utterance, where the user has previously observed the NPC utterance before; repetition of an utterance by the user after hearing a recording of the native speaker saying the utterance; the user reading an utterance out loud when presented with the text of the utterance; and the user saying an utterance in pieces after observing a recording of a native speaker saying each piece of the utterance.

26. The system of claim 25, wherein the utterances are associated with one of the nodes of the selected path of nodes.

27. The system of claim 15, wherein the conversation graph includes at least one of a SERIAL-group or groups of nodes, AND-group or groups of nodes, XOR-group or groups of nodes, and one or more optional nodes.

28. The system of claim 15, wherein the user model is based on at least one of:
(a) a projected amount of time left in a current training session;
(b) a projected amount of time left in overall training for a current conversational content set;
(c) the system's estimate of the user's knowledge based on direct observations;
(d) the system's estimate of the user's knowledge where the user's knowledge can be inferred from evidence other than direct observations of that knowledge;
(e) the system's estimate of the user's abilities, based on direct observations;
(f) the system's estimate of the user's abilities where the user's abilities can be inferred from evidence other than direct observations of those abilities;
(g) available content in upcoming complementary live instruction; and
(h) a predicted maximum rate of target language mastery by the user.

29. A method for constructing a dialogue for use in teaching a user a target language, the method comprising:
generating a conversation graph of the target language, the graph including a plurality of nodes, each of the nodes including multiple NPC utterances, each of which is capable of eliciting a certain utterance from the user;
training the user, in a computer process, on one or more of the nodes; and
selecting, in a computer process, a path of nodes through the graph to present to the user, the path of nodes selected based on results of the training, to present to the user.

30-32. (canceled)

33. The method of claim 29, wherein the selection of the path of nodes is performed using a user model which is updated based on the results of training.

34. The method of claim 33, wherein the user model is based on at least one:
(a) a projected amount of time left in a current training session;
(b) a projected amount of time left in overall training for a current conversation set;
(c) an estimate of the user's knowledge, based on direct observations;
(d) an estimate of the user's knowledge where the user's knowledge can be inferred from evidence other than direct observations of that knowledge;
(e) an estimate of the user's abilities, based on direct observations;
(f) an estimate of the user's abilities, where the user's abilities can be inferred from evidence other than direct observations of those abilities;
(g) available content in upcoming complementary live instruction; or
(h) a predicted maximum rate of target language mastery by the user.

35. The method of claim 1, wherein the execution of the path of nodes includes presenting the path of nodes to an interlocutor to present during a studio session or live instruction.

36. (canceled)

37. The method of claim 29, further comprising presenting, in a computer process, the path of nodes to an interlocutor to present during a studio session or live instruction.
